(19) United States
(12) Patent Application Publication
(10) Pub. No.: US 2006/0218430 A1
(43) Pub. Date: Sep. 28, 2006

(54) System and method for allocating transactions to a plurality of computing systems

(75) Inventors: Cesar Augusto Fonticielha De Rose, Porto Alegre (BR); Marco Aurelio Stelmar Netto, Port Alegre (BR); Caroline Bellan Oliva, Porto Alegre (BR); Caio Northfleet, Porto Alegre (BR)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: HEWLETT-PACKARD DEVELOPMENT COMPANY, L.P.

(21) Appl. No.: 11/386,101

(22) Filed: Mar. 22, 2006

(30) Foreign Application Priority Data
Mar. 23, 2005 (GB) 0505905.0

(51) Int. Cl. G06F 11/00

(52) U.S. Cl. 714/4

(57) ABSTRACT

The invention provides a method for determining the allocation of a transaction cluster to a plurality of computing systems. For the plurality of computing systems there is obtained a baseline indicator of the time taken to execute a baseline transaction cluster. The allocation of transactions in the cluster is modified and the modified cluster is executed to determine the time taken to execute the modified cluster. If the time taken by the modified cluster is less than the time taken by the baseline cluster, the modified cluster is set as the new baseline cluster.

### FIELD OF THE INVENTION

The present invention provides a system and method for allocating transactions to a plurality of computing systems, and specifically, but not exclusively, to a system and method for balancing the processing load across a plurality of computing systems.

### BACKGROUND OF THE INVENTION

In instances where there is a high demand for transaction processing ability, a plurality of computing systems may be utilized to run multiple instances of an application, such that, when multiple clusters of transactions arrive, they can be allocated to one of the computing systems in the plurality of computing systems in order to balance the computing load amongst the plurality of computing systems.

In some instances, the applications executed on the computing systems are so-called “single program multiple data” applications. That is, each computing system runs the same application, but different transaction clusters are processed by each of the computing systems.

An example of such a system may be a scientific application which is arranged to perform a simulation (for example, a Monte Carlo simulation of a nuclear system). As millions (or billions) of calculations must be performed and it would be time consuming for one computing system to perform the billions of calculations, such an application may be split into smaller components, which are each sent to one of a plurality of computing systems. This spreads the processing load across a number of computing systems, thereby allowing the calculations to be performed in less time. All computing systems in the plurality run the same application, but each computing system in the plurality receives a different transaction cluster (i.e. different data to process).

In order to balance the load across each of the computing systems, a load balancing algorithm may be used. In homogeneous clusters of computing systems (i.e. where all computing systems are identical) static load balancing is accomplished by assigning the same number of transactions to each computing system.

In heterogeneous clusters, however, each computing system may have a different computational ability and if the load placed on each computing system is not compensated to take the differing processing abilities of each computing system into account, the faster computing systems finish first and have to wait for the slower computing systems. This has a negative effect on overall performance.

There are applications which utilize static load balancing algorithms. Such algorithms are not generic, since they depend knowledge of the specific input data being provided to the applications. Dynamic load balancing may also be utilized. Both approaches depend on modifications to the application source code. Therefore, the success of such algorithms is heavily dependent on the programmer's programming skills and knowledge of the application and in-depth knowledge of the utilized hardware.

### SUMMARY OF THE INVENTION

In a first aspect, the invention provides a method for determining the allocation of a transaction cluster to a plurality of computing systems. For the plurality of computing systems there is obtained a baseline indicator of the time taken to execute a baseline transaction cluster. The allocation of transactions in the cluster is modified and the modified cluster is executed to determine the time taken to execute the modified cluster. If the time taken by the modified cluster is less than the time taken by the baseline cluster, the modified cluster is set as the new baseline cluster.

### BRIEF DESCRIPTION OF THE DRAWINGS

Notwithstanding any other forms which may fall within the scope of the present invention, a preferred embodiment will now be described, by way of example only, with reference to the accompanying drawings in which:

FIG. 1 is a schematic diagram of a computing system suitable for use with an embodiment of the present invention;

FIG. 2 is a cluster of computing systems on which an embodiment in accordance with the invention may be executed;

FIG. 3 is a flowchart depicting a methodology in accordance with an embodiment of the present invention; and

FIG. 4 is a flowchart depicting the steps carried out by the methodology when a transaction cluster is processed.

### DETAILED DESCRIPTION

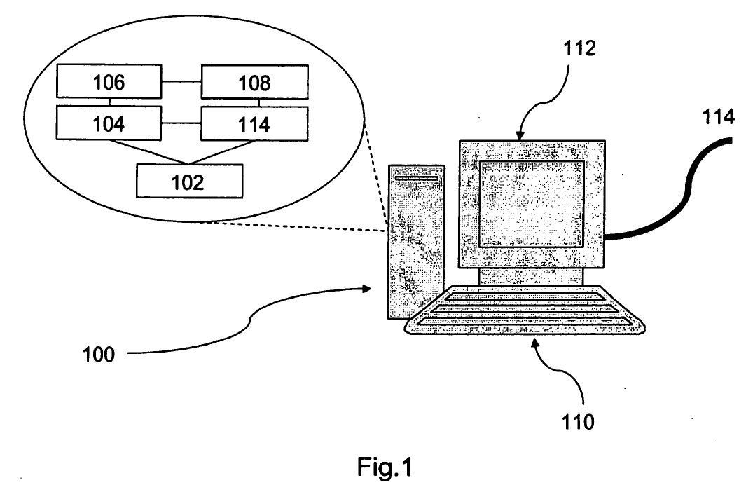

FIG. 1 shows a schematic diagram of a computing system 100 suitable for use with an embodiment of the invention. The computing system 100 may be used to execute applications which can receive transaction clusters. The computing system 100 may include a processor 102, read-only memory (ROM) 104, random access memory (RAM) 106, and input/output devices such as disk drives 108, keyboard 110, mouse (not shown), display 112, printer (not shown), and communications link 114.

The computer includes applications that may be stored in RAM 106, ROM 104, or disk drives 108 and may be executed by the processor 102. The communications link 114 connects to a computer network but could be connected to a telephone line, an antenna, a gateway or any other type of communications link.

Disk drives 108 may include any suitable storage media, such as, for example, floppy disk drives, hard disk drives, CD ROM drives or magnetic tape drives. The computing system 100 may use a single disk drive or multiple disk drives. The computing system 100 may use any suitable operating system, such as Windows™ or Unix™.

It will be understood that the computing system described in the preceding paragraphs is illustrative only, and that embodiments may be executed on any suitable computing system, with any suitable hardware and/or software.

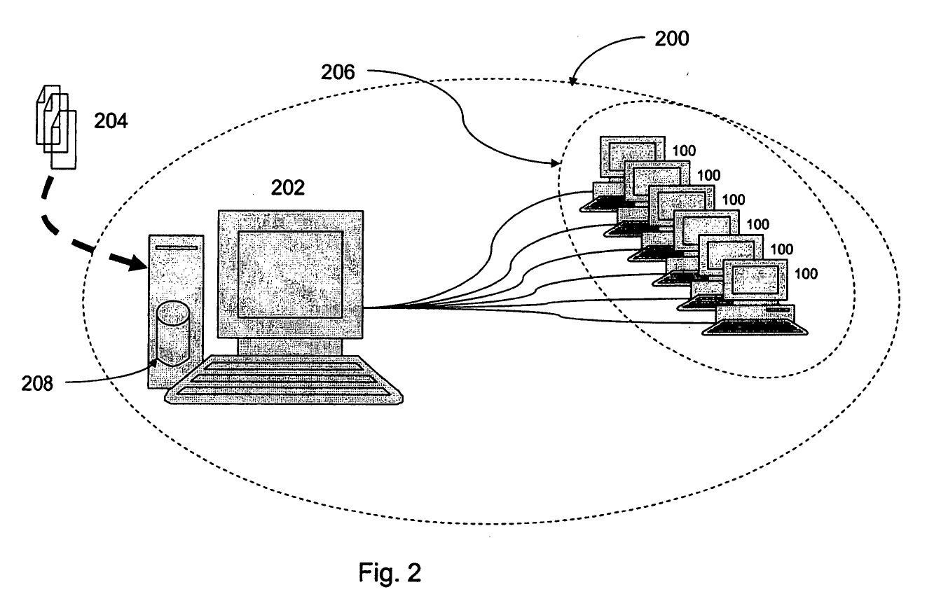

FIG. 2 is a diagram showing a computing system network 200 comprising computing systems 100 of FIG. 1 networked such that data may be interchanged between the networked computer systems. The networked computer system 200 may include a server 202 arranged to allocate an incoming transaction cluster 204 amongst the plurality of computing systems (generally denoted as a collective by numeral 206). Data related to the transaction cluster 204 is maintained in one or more databases 208 contained in storage media controlled by the server 202.

The embodiment described herein pertains to a method and system for allocating a transaction cluster amongst each of the computing systems 100 in the plurality of computing systems 206. The method may be used in heterogeneous networks (i.e. where each of the computing systems 100 has a different processing ability).

The embodiment is directed to improving the performance of “Single Program Multiple Data” applications, without requiring the user to have a particular knowledge of the application behavior and/or the architecture of each of the computing systems 100 in the plurality of computing systems 206.

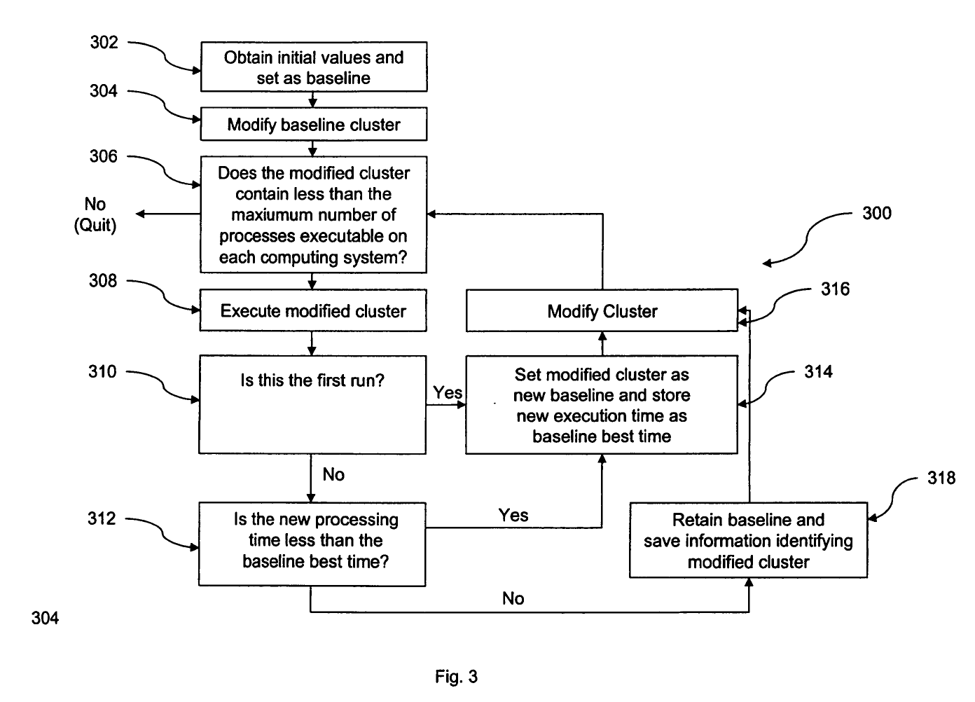

Referring to FIG. 3, the flow chart 300 describes method steps in accordance with the embodiment. At step 302, benchmark tools are utilized to obtain initial values regarding the execution time of a particular transaction cluster for a particular allocation amongst each of the computing systems in the cluster. A transaction cluster will generally be comprised of a plurality of transactions. It will be noted that any suitable benchmark tool may be utilized to obtain the initial values. Examples of such benchmark tools include NAS, LINPACK and PARKBENCH, but any proprietary benchmark tool which provides an initial value of the time taken for a predefined number of transactions (a transaction cluster) may be utilized.

The initial values, once obtained, are utilized to determine how the transaction cluster will be split amongst the plurality of computing systems. This determines a “baseline” profile for the transaction cluster.

As the initial profile may not be ideal, tuning of the values may be achieved by modifying the number of transactions allocated to each of the plurality of computing systems. That is, the cluster is modified to produce a different spread of transactions amongst the plurality of computing systems. The modified cluster is checked at step 306 to determine whether the cluster contains less than the maximum allowable number of processes that can be executed on each computing system. If not, the process is aborted, as the cluster is allowable. The modified cluster is then executed on the plurality of computing systems (step 308).

At step 310, a check is made to determine whether the modified cluster has been run for the first time. If so, then the cluster information is saved at step 314, and the process proceeds to step 316, where the cluster is modified and the process begins anew (i.e. the process returns to step 306).

If it is not the first run of the process, the process proceeds to step 312, where the time spent executing the modified transaction cluster is compared to the time taken to execute baseline transaction cluster.

If less time has been spent executing the modified transaction cluster, then the embodiment progresses to step 314, where the modified cluster profile and the time taken to execute the modified cluster are stored.

If more time is taken to execute the modified cluster, then the embodiment progresses to step 318 and only the modified transaction cluster profile is stored. By storing unsuccessful results, the embodiment is prevented from attempting to reutilize the unsuccessful profile.

The tuning stage may be performed during idle times (i.e. when there is little or no demand on the plurality of computing systems) to reduce possible disturbance to regular users. However, it will be understood that the tuning stage may also be performed on a “live” system.

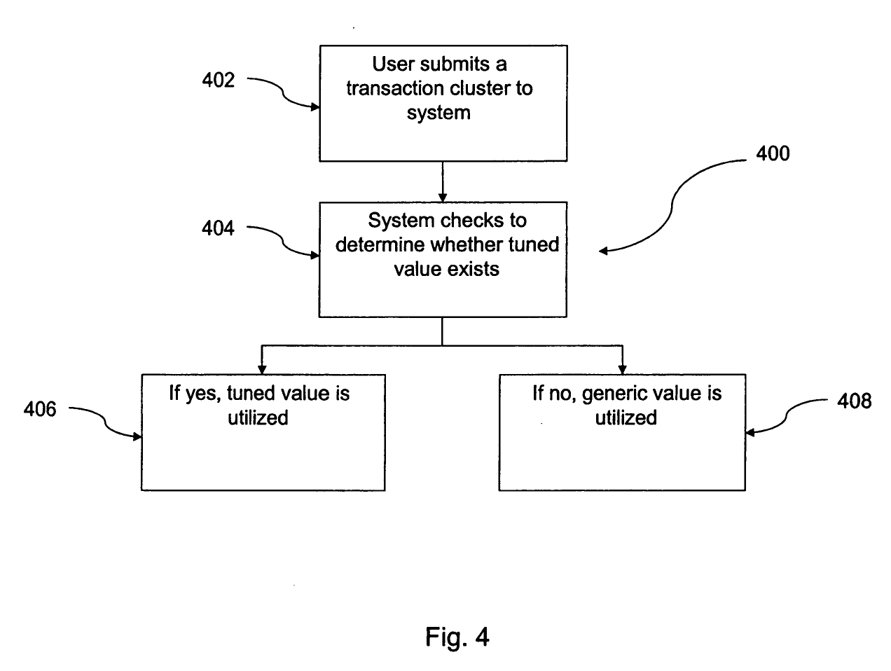

FIG. 4 depicts a flow chart 400 of the user's interaction with the tuned system. When a user submits a transaction cluster to the plurality of computing system at step 402, the system determines, at step 404, whether a tuned value for the submitted transaction cluster exists. If so, the system proceeds to step 406 and the tuned value is utilized. Otherwise, the system proceeds to step 408 and the baseline values are utilized.

An example of the embodiment will now be provided for the purposes of illustration. The example is provided to further illustrate the embodiment and should not be construed as a limitation on the embodiment.

In the example, it is assumed that there are 20 computing systems, some with different processing abilities. For the sake of simplicity, it is assumed that the 20 computing systems are of 3 types, namely:
10 Pentium III (2*550 MHz)—Type A
5 Pentium III (2*1000 MHz)—Type B
5 Itanium II (700 MHz)—Type C

It is further assumed that a user is allocated the following quantity of computing systems:
2 Type A Computing Systems
2 Type B Computing Systems
2 Type C Computing Systems

It is assumed that from initial information gathered from a benchmarking program, the minimum number of transactions which can be provided are:
2 transactions can be executed on Type A Computing Systems;
2 transactions can be executed on Type B Computing Systems; and
1 transaction can be executed on Type C Computing Systems.

An administrator (or perhaps the user) can define the maximum amount of transactions to be executed on each type of computing system. In this example, these values are set at 10, 12 and 10 for Type A, B and C respectively.

The user utilises a benchmarking software application to estimate the best combination of transactions amongst the computing systems, passing the application name and it's input parameters.

An application in accordance with the embodiment is able to retrieve the information about each computing system. The application executes several combinations such as:
(2,4,2) (amount of process per node of each type, A, B, C respectively)
(3,3,2)
(5,10,3)
(7,9,2)

During execution, the application can discard some combinations based on the optimization history and the capability of each of the computing systems. For example, if it is found (from the database) that the combination (10, 10, 1) is not a useful combination because a type C computing system is faster than type A and B computing systems, then it will not be utilised as a possible combination.

Other conditions may also be imposed using the application, such as a condition that there will never be more transactions in a Type A Computing System than in a Type B Computing System, since both computing systems have the same family processor, and Type B is faster than Type A. Other optimizations may include the ability to interrupt an execution if execution takes longer than the fastest execution time in the database so far.

Table 1 shows the optimization of an application that only accepts squared sum of transaction processors.

TABLE 1
Number of Transaction Clusters Allocated to Each
Computing System, and Total Extension Time for said
Allocation Benchmark SP (2*Type A, 2* Type B, 2* Type C)

| | | | Sum Of | | |
|---|---|---|---|---|---|
| | | | Transaction | Execution | |
| Type A | Type B | Type C | Clusters | Time | |
| 2 | 2 | 4 | 16 | 254 s | |
| 2 | 3 | 3 | 16 | 267 s | |
| 2 | 4 | 2 | 16 | 268 s | |
| 2 | 5 | 1 | 16 | 267 s | |
| 3 | 3 | 2 | 16 | 267 s | |
| 3 | 4 | 1 | 16 | 267 s | |
| 2 | 6 | 10 | 36 | 263 s | |
| 2 | 7 | 9 | 36 | 268 s | |
| 2 | 8 | 8 | 36 | 267 s | |
| 2 | 9 | 7 | 36 | 268 s | |
| 2 | 10 | 6 | 36 | 267 s | |
| 2 | 11 | 5 | 36 | 267 s | |
| 2 | 12 | 4 | 36 | 268 s | |
| 3 | 5 | 10 | 36 | 245 s | |
| 3 | 6 | 9 | 36 | 250 s | |
| 3 | 7 | 8 | 36 | 259 s | |
| 3 | 8 | 7 | 36 | 258 s | |
| 3 | 9 | 6 | 36 | 259 s | |
| 3 | 10 | 5 | 36 | 258 s | |
| 3 | 11 | 4 | 36 | 258 s | |
| 3 | 12 | 3 | 36 | 259 s | |
| 4 | 4 | 10 | 36 | 242 s | |
| 4 | 5 | 9 | 36 | 235 s | <----- Best |
| | | | | | Execution Time |
| 4 | 6 | 8 | 36 | 236 s | |
| 4 | 7 | 7 | 36 | 236 s | |
| 4 | 8 | 6 | 36 | 236 s | |
| 4 | 9 | 5 | 36 | 236 s | |
| 4 | 10 | 4 | 36 | 236 s | |
| 4 | 11 | 3 | 36 | 236 s | |
| 4 | 12 | 2 | 36 | 236 s | |
| 5 | 5 | 8 | 36 | 236 s | |
| 5 | 6 | 7 | 36 | 236 s | |
| 5 | 7 | 6 | 36 | 236 s | |
| 5 | 8 | 5 | 36 | 236 s | |
| 5 | 6 | 7 | 36 | 236 s | |
| 5 | 7 | 6 | 36 | 236 s | |
| 5 | 8 | 5 | 36 | 236 s | |
| 5 | 9 | 4 | 36 | 236 s | |
| 5 | 10 | 3 | 36 | 236 s | |
| 5 | 11 | 2 | 36 | 236 s | |
| 5 | 12 | 1 | 36 | 236 s | |
| 6 | 6 | 6 | 36 | 236 s | |
| 6 | 7 | 5 | 36 | 236 s | |
| 6 | 8 | 4 | 36 | 236 s | |
| 6 | 9 | 3 | 36 | 236 s | |
| 6 | 10 | 2 | 36 | 236 s | |
| 6 | 11 | 1 | 36 | 236 s | |
| 7 | 7 | 4 | 36 | 236 s | |
| 7 | 8 | 3 | 36 | 236 s | |
| 7 | 9 | 2 | 36 | 236 s | |
| 7 | 10 | 1 | 36 | 236 s | |
| 8 | 8 | 2 | 36 | 236 s | |
| 8 | 9 | 1 | 36 | 236 s | |

In table 1, all executions after combination (4, 5, 9) have been interrupted, since for these executions the combination takes longer than the best execution time of 236 seconds (combination (4,5,9)).

The embodiment provides a largely automated method for analyzing different transaction clusters and determining the profile that provides better load balance and consequently achieves more efficient performance.

The embodiment is not encoded in the source code of an application that is run on each computing systems, so it may be applied to any system running any software application. In other words, the embodiment is not architecture or application specific.

The embodiment can also be used for sequential applications, like parameter sweep applications. That is, in applications where the same routines or functions are run for a series of different input parameters. Such applications are common in computer simulations that need to sweep a wide range of parameters and therefore need a wide number of executions.

Furthermore, load balancing is preferably more efficient without requiring user intervention to compensate for the differences in the processing power of each of the computing systems in a heterogeneous cluster.

Moreover, the applications residing on each of the computing systems 100 do not need to be modified, since the load balancing is carried out externally from any applications residing on each of the computing systems.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1. A method for determining the allocation of transaction clusters to a plurality of computing systems, comprising the steps of, for each of the computing systems, obtaining a baseline indicator of the time taken to execute a baseline transaction cluster, modifying the transaction cluster, executing the modified cluster, determining the time taken to execute the modified cluster, and if the time taken by the modified cluster is less than the time taken by the baseline cluster, utilising the modified cluster as the baseline cluster for future allocations.

2. A method in accordance with claim 1, comprising the further preliminary step of estimating the number of transactions which may be executed on a computing system over a given time period, and utilising the estimate as the baseline transaction cluster.

3. A method in accordance with claim 1, comprising the further step of modifying the transaction cluster by varying the total number of transactions sent to each of the computing systems in the plurality of computing systems.

4. A method in accordance with claim 2, comprising the further step of, after executing the modified cluster, retaining the information describing the transaction cluster and the time taken to execute the modified cluster.

5. A method in accordance with claim 2, comprising the further step of, before executing the modified cluster, checking to determine whether the results of an identical modified cluster has been executed, and if so, not executing the modified transaction cluster.

6. A method in accordance with claim 1, comprising the further step of, if the modified cluster, during execution, passes the time taken by the baseline cluster, stopping execution of the modified cluster.

7. A method in accordance with claim 1, further comprising the step of determining a baseline configuration by utilizing a benchmark tool.

8. A system for determining the allocation of transaction clusters to a plurality of computing systems, comprising means for accessing a baseline indicator of the time taken to execute a baseline transaction cluster on each of the plurality of computing system, computing means for modifying the transaction cluster, executing means for executing the modified cluster, determining means for determining the time taken to execute the modified cluster, wherein, if the time taken by the modified cluster is less than the time taken by the baseline cluster, the modified cluster is retained in a database as the baseline cluster.

9. A system in accordance with claim 8, comprising estimating means to estimate the number of transactions which may be executed on a computing system over a given time period, wherein the estimate is utilised as the baseline indicator.

10. A system in accordance with claim 9, comprising modifying means to modify the transaction cluster by varying the total number of transactions sent to each of the computing systems in the plurality of computing systems.

11. A system in accordance with claim 9, comprising a database to retain the information describing the modified cluster and the time taken to execute the modified cluster.

12. A system in accordance with claim 9, comprising checking means to determine whether the results of an identical modified cluster has been executed, wherein, if so, the information describing the cluster is not retained.

13. A system in accordance with claim 8, further comprising a benchmarking module arranged to provide a baseline transaction cluster execution time.

14. A method of processing a transaction cluster, comprising the steps of analysing the incoming transaction cluster to determine the number of transactions, utilizing the analysis to determine whether an optimized transaction processing profile is available, and if so, utilizing the optimized transaction processing profile.
